(19) United States
(12) Patent Application Publication
(10) Pub. No.: US 2017/0222498 A1
(43) Pub. Date: Aug. 3, 2017

(54) Motor Stator and Method for Forming Motor Stator

(71) Applicant: Johnson Electric S.A., Murten (CH)

(72) Inventors: Yue LI, Hong Kong (CN); Tao ZHANG, Shenzhen (CN); Jie CHAI, Shenzhen (CN); Chui You ZHOU, Shenzhen (CN)

(21) Appl. No.: 15/421,527

(22) Filed: Feb. 1, 2017

(30) Foreign Application Priority Data
Feb. 1, 2016 (CN) 2016 1007 0892.1

(51) Int. Cl. H02K 1/14; H02K 15/02; H02K 15/095; H02K 3/18

(52) U.S. Cl. CPC H02K 1/146; H02K 3/18; H02K 15/022; H02K 15/095

(57) ABSTRACT

A motor stator and a method for forming the motor stator are provided. The method includes the steps of: providing a plurality of plates or metal powder, forming the plate or the metal powder into a plurality of magnetic laminations, wherein each magnetic lamination comprises a yoke portion and a plurality of stator teeth, each of the stator teeth comprises a tooth portion and two pole shoes, and one end of one of the pole shoes extends towards the direction away from the yoke portion to form a bent portion; axially overlapping the plurality of magnetic laminations and fixing the magnetic laminations to form a stator core; winding wires to the stator core; and bending the bent portions towards adjacent stator teeth, to form a smooth transition connection between the bent portions and the pole shoes connected thereto. The method makes the winding convenient and fast.

### CROSS REFERENCE TO RELATED APPLICATIONS

This non-provisional patent application claims priority under 35 U.S.C. §119(a) from Patent Application No. 201610070892.1 filed in The People's Republic of China on Feb. 1, 2016.

### FIELD OF THE INVENTION

The present disclosure relates to the field of motors, more particularly, to a motor stator and a method for forming a motor stator.

### BACKGROUND OF THE INVENTION

With regard to a motor, stator windings are generally wound on a stator core, and energized to generate a variable magnetic field, in order to drive a rotor embedded with permanent magnets to rotate. The stator core generally includes an annular yoke portion and a plurality of tooth portions extending inwards from the yoke portion. The stator windings are wound on the tooth portions, and a slot is defined between two adjacent tooth portions. However, too wide slot will result in increased magnetic resistance between a part, where the slot is defined, of the stator core and the permanent magnets of the rotor, and too small slot will result in difficult winding.

### SUMMARY OF THE INVENTION

In view of the above, the present disclosure aims to provide a motor stator and a method for forming the motor stator that is convenient to wind.

A motor stator includes a stator core. The stator core includes a yoke portion and a plurality of stator teeth extending from the yoke portion. Each stator tooth includes a tooth portion and two pole shoes extending from a distal end to two circumferential sides of the tooth portion. A bent portion is formed on a distal end of one of the pole shoes of each stator tooth, the bent portion is bendable between a first position extending away from the yoke portion and a second position connected to the pole shoe in a circumferential direction of the stator core to allow each stator tooth to form a long pole shoe and a short pole shoe of different lengths.

As a preferred embodiment, the motor stator is a single phase motor stator.

As a preferred embodiment, when the bent portions are in the second position, each bent portion is smoothly connected to the corresponding pole shoe, inner and outer surfaces of each bent portion are respectively smoothly connected to inner and outer surfaces of the corresponding pole shoe.

As a preferred embodiment, pole arc surfaces of the long pole shoe and the short pole shoe on a same stator tooth are located on a same cylindrical surface.

As a preferred embodiment, the bent portions are respectively formed on distal ends of the pole shoes at the same sides of the stator teeth.

As a preferred embodiment, a circumferential width of a notch between each long pole shoe and a short pole shoe of an adjacent stator tooth upon a condition that the bent portions are in the second position is less than ½ of a circumferential width of an opening between each bent portion and the adjacent stator tooth upon a condition that the bent portions are in the first position.

As a preferred embodiment, when the bent portions are in the first position, each bent portion is parallel with the tooth portion of the corresponding stator tooth.

A motor stator includes a stator core and windings. The stator core includes a yoke portion and a plurality of stator teeth extending from the yoke portion. Each stator tooth includes a tooth portion and two pole shoes extending from a distal end to two circumferential sides of the tooth portion. The windings are wound around at least two of the stator teeth. A bent portion is formed on a distal end of one of the pole shoes of each stator tooth with windings, the bent portion is bendable between a first position extending away from the yoke portion and a second position connected to the corresponding pole shoe in a circumferential direction of the stator core to allow the stator tooth to form a long pole shoe and a short pole shoe of different lengths.

As a preferred embodiment, the motor stator is a single phase motor stator.

As a preferred embodiment, when the bent portions are in the second position, each bent portion is smoothly connected to the corresponding pole shoe, inner and outer surfaces of each bent portion are respectively smoothly connected to inner and outer surfaces of the corresponding pole shoe.

A method for forming a motor stator, includes the steps of: providing a plurality of plates or metal powder, forming the plate or the metal powder into a plurality of magnetic laminations, wherein each magnetic lamination comprises a yoke portion and a plurality of stator teeth, each of the stator teeth comprises a tooth portion and two pole shoes, and one end of one of the pole shoes extends towards the direction away from the yoke portion to form a bent portion; axially overlapping the plurality of magnetic laminations and fixing the magnetic laminations to form a stator core; winding wires to the stator core; and bending the bent portions towards adjacent stator teeth, to form a smooth transition connection between the bent portions and the pole shoes connected thereto.

As a preferred embodiment, each magnetic lamination in step a is formed by stamping an amorphous, microcrystal or nanocrystalline alloy plate, and the stamping process is a blanking process and/or a punching process.

As a preferred embodiment, each magnetic lamination in step a is formed by one of the means of laser cutting, plasma cutting, water cutting, wire cutting, flame cutting and chemical corrosion cutting of an amorphous, microcrystal or nanocrystalline alloy plate.

As a preferred embodiment, each magnetic lamination in step a is formed by a powder metallurgy process.

As a preferred embodiment, in step a, each bent portion and the corresponding tooth portion are substantially arranged in parallel, and an opening, with circumferential width of 2 mm, is formed between the bent portion and the pole shoe without bent portion of the adjacent stator tooth.

As a preferred embodiment, after the step d, inner and outer surfaces of each bent portion are respectively smoothly connected to inner and outer surfaces of the corresponding pole shoe, and each stator tooth forms a long pole shoe and a short pole shoe of different lengths.

As a preferred embodiment, a notch, with circumferential width of 0.8 mm, is formed between the long pole shoe of each stator tooth and the short pole shoe of the adjacent stator tooth.

As a preferred embodiment, a chamfer is formed on an end of the inner surface of the short pole shoe next to the notch.

As a preferred embodiment, the notch deviates from a symmetric center of an adjacent tooth portion for 45 to 135 electric degrees.

As a preferred embodiment, the motor stator is a single phase motor stator.

According to the motor stator and method for forming the stator provided by the present disclosure, the bent portion is formed on one of the two pole shoes of the stator tooth, the bent portion is away from the yoke portion before winding operation, by this time, a large opening is formed between the bent portion and the pole shoe of the adjacent stator tooth, to facilitate the subsequent winding operation, and the bent portion is bent to smoothly connected to the corresponding stator tooth after the winding operation, in order to form a complete stator. According to the above method, fast and convenient winding can be realized.

### BRIEF DESCRIPTION OF THE DRAWINGS

FIG. 1 is a perspective, schematic view of a motor of an embodiment of the present disclosure.

FIG. 2 is a perspective, schematic view of a stator of FIG. 1.

FIG. 3 is a perspective, schematic view of a stator core of FIG. 2, wherein the stator core includes a plurality of bent portions in a first position.

FIG. 4 is similar to FIG. 3, but the bent portions are in a second position.

### DETAILED DESCRIPTION OF THE EMBODIMENTS

More clear and complete descriptions concerning the technical solution of the embodiments of the present invention will now be made with reference to the accompanying drawings of the embodiments of the present disclosure, obviously, the embodiments described hereof are just a partial embodiments of the present invention, rather than all embodiments of the present invention. All other embodiments obtained by those ordinary technicians in the art based on the embodiments of the present invention under the premise of making no contribution of creative work shall belong to the scope of the protection of the present invention.

It's important to note that when a component is referred to as being “fixed” to another component, it may be fixed directly on another component or there may be an intermediate component as well. When a component is identified as being “connected” to another component, it may be directly connected to another component or there may be an intermediate component at the same time. When a component is considered to be “provided on” another component, it may be provided directly on another component or there may be an intermediate component at the same time.

Unless otherwise defined, all technical and scientific terminologies used herein have the same meaning as commonly understood by technicians of the technical field to which the present invention belongs. The terminologies used herein in the descriptions of the present invention are for the purpose of describing particular embodiment only, they are not intended to limit the present invention.

The technical solution and other advantageous effects of the present invention will become apparent from the following detailed description of the preferred embodiments of the present disclosure with reference to the accompanying drawings. The accompanying drawings are provided for the purpose of illustration and description only other than limit the present invention. The dimensions as shown in the accompanying drawings are for convenience of illustration only, they won't limit the proportional relation.

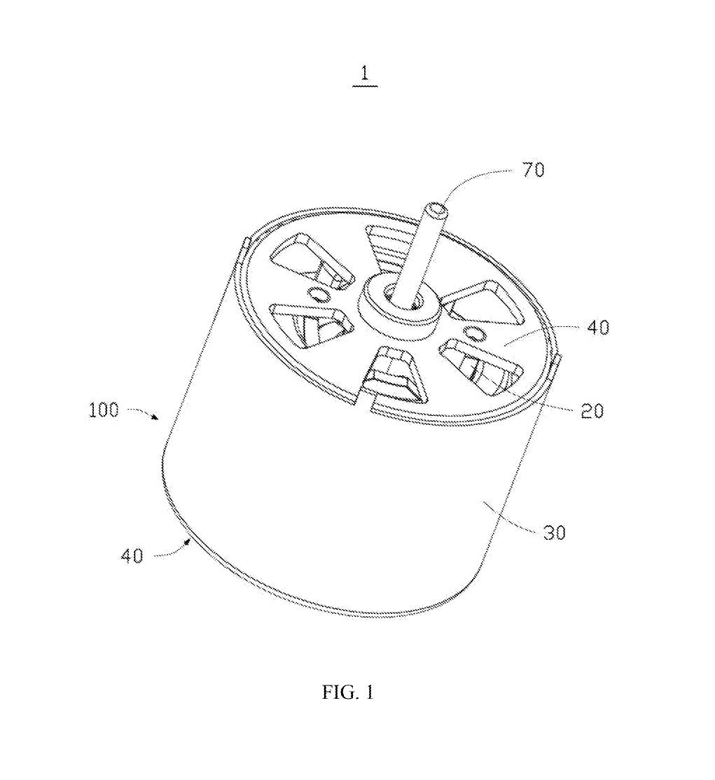

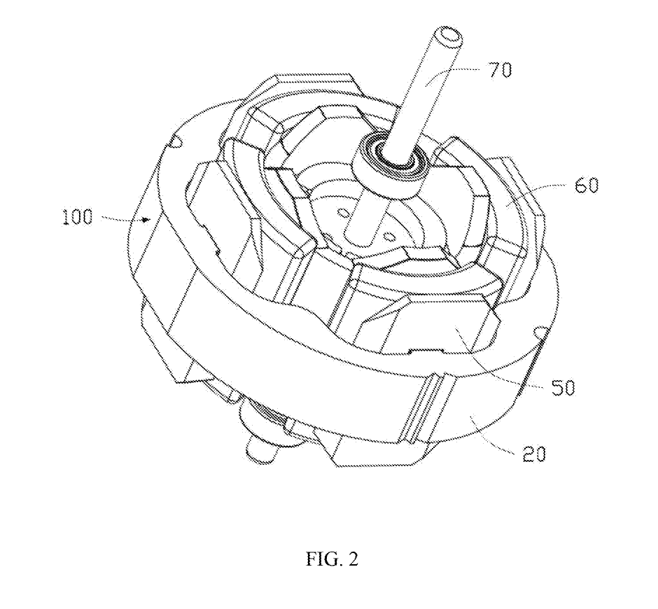

Please refer to FIGS. 1 and 2, a preferred embodiment of the present disclosure relates to a method for forming a stator 100 of a motor 1. Preferably, the motor 1 is a single-phase permanent magnet motor, and the number of permanent magnetic poles of a rotor of the motor 1 is equal to the number of poles of the stator 100. The stator 100 includes a stator core 20, a cylindrical housing 30 with an opening at one end thereof, an end cover 40 mounted on the opening of the housing 30, an insulated wire frame 50 mounted on the stator core 20, and windings 60 wound around the stator core 20 and supported by the insulated wire frame 50.

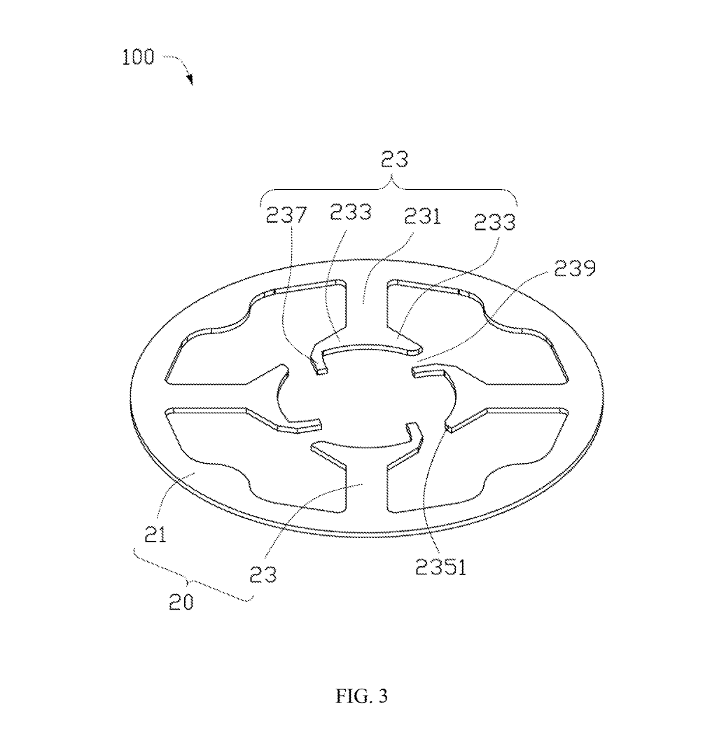

Referring to FIG. 3, the stator core 20 includes a one-piece formed external yoke portion 21, and a plurality of stator teeth 23 extending to the axis direction of the stator core 20 from the external yoke portion 21. Each stator tooth 23 includes a tooth portion 231 and two pole shoes 233, and the two pole shoes 233 extend from one end of the tooth portion 231 away from the external yoke portion 21 to two circumferential sides of the stator core 20.

The stator core 20 is made of a soft magnetic material with a magnetic property, for instance, is formed by stacking magnetically permeable laminations (silicon steel sheets commonly used in the industry) in the axial direction of the motor. Preferably, the tooth portions 231 of the stator core 20 are uniformly distributed at intervals along the inner circumferential side of the external yoke portion 21.

Each stator tooth 23 further comprises a bent portion 237, which is formed by extending from one end of one of the pole shoes 233 of the stator tooth 23 towards the direction away from the external yoke portion 21 and the corresponding tooth portion 231 in a first position. Each bent portion 237 and the corresponding tooth portion 231 are generally arranged in parallel. An opening 239 is defined between the bent portion 237 and the pole shoe 233 without bent portion 237 of the adjacent stator tooth 23, in order for winding. In this embodiment, the circumferential width of the opening 239 is 2 mm.

The bent portions 237 are respectively formed on distal ends of the pole shoes 233 at the same sides of the stator teeth 23.

It can be comprehended that each bent portion 237 needs to be bent to a second position after the windings 60 are wound on the stator 100.

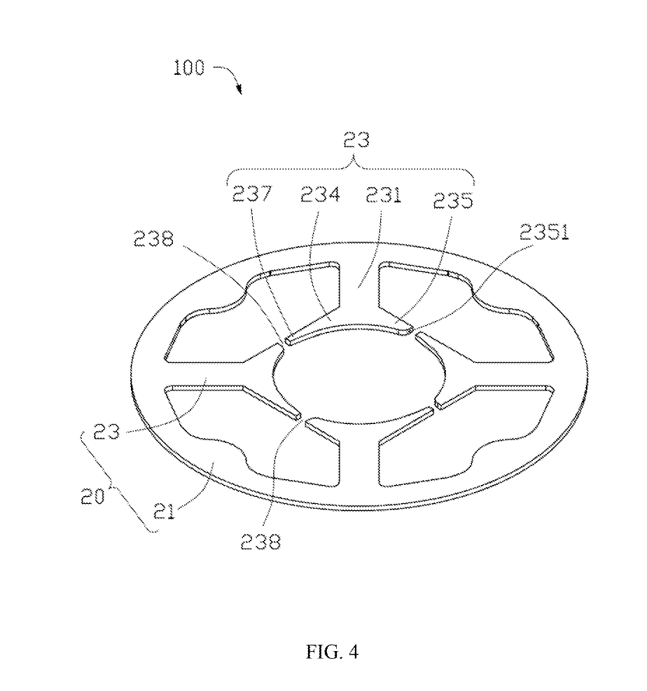

Please refer to FIG. 4, in this embodiment, after the bent portions 237 are bent to the second position, each bent portion 237 is smoothly connected to the pole shoe 233 connected thereto, and inner and outer surfaces of each bent portion 237 are respectively smoothly connected to inner and outer surfaces of the pole shoe 233 connected to the bent portion 237, so as to jointly form a long pole shoe 234. Therefore, each stator tooth 23 is provided with a long pole shoe 234 and a short pole shoe 235 of different lengths, and pole arc surfaces of the long pole shoe 234 and the short pole shoe 235 on the same stator tooth 23 are located on the same cylindrical surface. Such setting can drive a rotor 70 of the motor to deviate from the dead point at the initial position. A notch 238, with circumferential width of 0.8 mm, is defined between the long pole shoe 234 of each stator tooth 23 and the short pole shoe 235 of the adjacent stator tooth 23. The notch 238 deviates from the symmetric center of an adjacent tooth portion 231 for 45 to 135 electrical degrees. In this embodiment, the circumferential width of the notch 238 is less than ½ of the circumferential width of the opening 239.

Preferably, a chamfer 2351 is formed on an end of the inner surface of the short pole shoe 235 next to the notch 238. The arrangement of the chamfer 2351 may further reduce the area of one end of the short pole shoe 235, and further increase the unevenness of the long pole shoe 234 and the short pole shoe 235, i.e. further drive the rotor 70 to deviate from the dead point at the initial position.

The radial thicknesses of the long pole shoe 234 and the short pole shoe 235 of each stator tooth 23 gradually decrease along the direction from the center line of the tooth portion 231 to the notch 238, so that the magnetic resistance of the long pole shoe 234 and the short pole shoe 235 gradually increase in the direction from the tooth portion 231 to the notch 238. Based on the design, the motor can operate more stably and start more reliably. Each notch 238 deviates from the center line of two adjacent tooth portions 231, so that the long pole shoe 234 and the short pole shoe 235 connected to the tooth portion are asymmetric with respect to the center of the tooth portion 231, i.e. a pole shoe with greater cross section and a pole shoe with smaller cross section are formed.

The method for forming the stator 100, comprising the following steps:

S1: providing a plurality of plates or metal powder, forming the metal powder into magnetic laminations through powder metallurgy process; or forming each plate into a magnetic lamination by a stamping process, the plate could be amorphous, microcrystal or nanocrystalline alloy plate, and the stamping process is a blanking process.

It can be comprehended that the stamping process can be a punching process.

It can be comprehended that the magnetic lamination can be formed by conducting any means of laser cutting, plasma cutting, water cutting, wire cutting, flame cutting and chemical corrosion to the plates.

S2: axially overlap and fix the plurality of magnetic laminations to form the stator core 20. The stator core 20 includes an external yoke portion 21, a plurality of stator teeth 23 extending to the axis direction of the stator core 20 from the external yoke portion 21. Each stator tooth 23 includes a tooth portion 231 and two pole shoes 233 respectively extending to two circumferential sides from one end of the tooth portion 231 away from the external yoke portion 21.

In this embodiment, the stator tooth 23 further comprises a bent portion 237, which is formed by extending one end of one of the pole shoes 233 of the stator tooth 23 towards the direction away from the external yoke portion 21 and the corresponding tooth portion 231 in a first position. Each bent portion 237 and the corresponding tooth portion 231 are generally arranged in parallel. An opening 239 is formed between the bent portion 237 and the pole shoe 233 without bent portion 237 of the adjacent stator tooth 23. The circumferential width of the opening 239 is 2 mm preferably.

The bent portions 237 are arranged on the same sides of the corresponding stator teeth 23.

It can be comprehended that the stator core 20 is formed by fixedly overlapping the plurality of magnetic laminations, so that the projection shape of the stator core 20 in the axial direction is the same as the shape and structure of each magnetic chip.

S3: provide and install an insulated wire frame 50 to the stator core 20.

S4: wind wires to the insulated wire frame 50 through the opening 239, so as to form the winding 60 of the stator 100.

S5: bend the bent portions 237 towards the opening 239 to a second position, in order to realize a smooth transition connection between the bent portions 237 and the pole shoes 233 connected thereto, and form a long pole shoe 234 and a short pole shoe 235 of different lengths on each stator tooth 23. Such setting can drive the rotor 70 of the motor to deviate from the dead point at the initial position. Preferably, a chamfer 2351 is formed on an end of the inner surface of the short pole shoe 235 next to the notch 238. The chamfer 2351 can be provided to further reduce the area of one end of the short pole shoe 235, but further increase the nonuniform extent of the long pole shoe 234 and the short pole shoe 235, i.e. further drive the rotor 70 to deviate from the dead point at the initial position.

A notch 238 is formed between the long pole shoe 234 on a stator tooth 23 and the short pole shoe 235 of the adjacent stator tooth 23. The notch 238 is 0.8 mm wide. The notch 238 deviates from the symmetric center of an adjacent tooth portion 231 for 45 to 135 electric degrees.

It can be comprehended that the bent portions 237 are arranged to be smoothly connected to the corresponding pole shoes 233 by an external force generated by stamping, pneumatic pressing, hydraulically pressing or the like.

Preferably, after the bent portions 237 are bent to the second position, the radial thicknesses of the long pole shoe 234 and the short pole shoe 235 of each stator tooth 23 are reduced gradually along the direction from the center line of the tooth portion 231 to the notch 238, so that the magnetic resistance between the long pole shoe 234 and the short pole shoe 235 is increased gradually in the direction from the tooth portion 231 to the notch 238. Based on the design, the motor can operate more stably and start more reliably. Each notch 238 deviates from the center of the two adjacent tooth portions 231, so that the long pole shoe 234 and the short pole shoe 235 connected to the tooth portion are asymmetric around the center of the tooth portion 231, i.e. a pole shoe with greater cross section and a pole shoe with smaller cross section are formed. Preferably, pole arc surfaces of all pole shoes 234 and 235 are located on the same cylindrical surface that is concentric with the rotor.

Step S6: assemble the stator 100. Provide a cylindrical housing 30 with an opening at one end, and an end cover 40 to be installed to the opening of the housing 30. Install the assembled winding 60, insulated wire frame 50 and stator core 20 to the cylindrical housing 30.

Then the end cover 40 may be mounted on the opening of the housing 30 after the rotor 70 is installed.

According to the method for forming the stator provided by the present disclosure, a bent portion 237 is formed on one of the two pole shoes 233 of each stator tooth 23, and when the magnetic lamination is formed by stamping, the bent portion 237 is towards the axis of the magnetic lamination relative to the pole shoes 233. By this time, a large opening 239 is formed between the bent portion 237 and the pole shoe 233 of the adjacent stator tooth 23, so as to facilitate the subsequent winding operation. After the winding operation is completed, the bent portions 237 are bent to be smoothly connected to the corresponding pole shoes 233 to form a complete stator 100. According to the above method, fast and convenient winding can be realized.

In other embodiments, the windings 60 may be wound around some of the stator teeth 23, the stator teeth 23 with windings 60 and the stator teeth without windings 60 are staggered arranged in the circumferential direction of the stator core 20, and the bent portions 237 are formed on the stator teeth 23 with windings 60.

What described above is a preferable embodiment of the present invention only, rather than any limit to the present invention in any way. Besides, those skilled in the art may make other variations within the spirit of the present invention. Of course, such variations made in accordance with the spirit of the present invention shall be comprised within the scope of protection of the present invention as claimed.

1. A motor stator comprising:
a stator core, comprising:
a yoke portion; and
a plurality of stator teeth extending from the yoke portion, each stator tooth comprising a tooth portion and two pole shoes extending from a distal end to two circumferential sides of the tooth portion;
wherein a bent portion is formed on a distal end of one of the pole shoes of each stator tooth, the bent portion is bendable between a first position extending away from the yoke portion and a second position connected to the pole shoe in a circumferential direction of the stator core to allow each stator tooth to form a long pole shoe and a short pole shoe of different lengths.

2. The motor stator according to claim 1, wherein the motor stator is a single phase motor stator.

3. The motor stator according to claim 2, wherein when the bent portions are in the second position, each bent portion is smoothly connected to the corresponding pole shoe, inner and outer surfaces of each bent portion are respectively smoothly connected to inner and outer surfaces of the corresponding pole shoe.

4. The motor stator according to claim 3, wherein pole arc surfaces of the long pole shoe and the short pole shoe on a same stator tooth are located on a same cylindrical surface.

5. The motor stator according to claim 4, wherein the bent portions are respectively formed on distal ends of the pole shoes at the same sides of the stator teeth.

6. The motor stator according to claim 5, wherein a circumferential width of a notch between each long pole shoe and a short pole shoe of an adjacent stator tooth upon a condition that the bent portions are in the second position is less than ½ of a circumferential width of an opening between each bent portion and the adjacent stator tooth upon a condition that the bent portions are in the first position.

7. The motor stator according to claim 2, wherein when the bent portions are in the first position, each bent portion is parallel with the tooth portion of the corresponding stator tooth.

8. A motor stator comprising:
a stator core comprising a yoke portion and a plurality of stator teeth extending from the yoke portion, each stator tooth comprising a tooth portion and two pole shoes extending from a distal end to two circumferential sides of the tooth portion; and
windings wound around at least two of the stator teeth;
wherein a bent portion is formed on a distal end of one of the pole shoes of each stator tooth with windings, the bent portion is bendable between a first position extending away from the yoke portion and a second position connected to the corresponding pole shoe in a circumferential direction of the stator core to allow the stator tooth to form a long pole shoe and a short pole shoe of different lengths.

9. The motor stator according to claim 8, wherein the motor stator is a single phase motor stator.

10. The motor stator according to claim 9, wherein when the bent portions are in the second position, each bent portion is smoothly connected to the corresponding pole shoe, inner and outer surfaces of each bent portion are respectively smoothly connected to inner and outer surfaces of the corresponding pole shoe.

11. A method for forming a motor stator, comprising the steps of:
a. providing a plurality of plates or metal powder, forming the plate or the metal powder into a plurality of magnetic laminations, wherein each magnetic lamination comprises a yoke portion and a plurality of stator teeth, each of the stator teeth comprises a tooth portion and two pole shoes, and one end of one of the pole shoes extends towards the direction away from the yoke portion to form a bent portion;
b. axially overlapping the plurality of magnetic laminations and fixing the magnetic laminations to form a stator core;
c. winding wires to the stator core; and
d. bending the bent portions towards adjacent stator teeth, to form a smooth transition connection between the bent portions and the pole shoes connected thereto.

12. The method according to claim 11, wherein each magnetic lamination in step a is formed by stamping an amorphous, microcrystal or nanocrystalline alloy plate, and the stamping process is a blanking process and/or a punching process.

13. The method according to claim 11, wherein each magnetic lamination in step a is formed by one of the means of laser cutting, plasma cutting, water cutting, wire cutting, flame cutting and chemical corrosion cutting of an amorphous, microcrystal or nanocrystalline alloy plate.

14. The method according to claim 11, wherein each magnetic lamination in step a is formed by a powder metallurgy process.

15. The method according to claim 11, wherein in step a, each bent portion and the corresponding tooth portion are substantially arranged in parallel, and an opening, with circumferential width of 2 mm, is formed between the bent portion and the pole shoe without bent portion of the adjacent stator tooth.

16. The method according to claim 11, wherein after the step d, inner and outer surfaces of each bent portion are respectively smoothly connected to inner and outer surfaces of the corresponding pole shoe, and each stator tooth forms a long pole shoe and a short pole shoe of different lengths.

17. The method according to claim 16, wherein a notch, with circumferential width of 0.8 mm, is formed between the long pole shoe of each stator tooth and the short pole shoe of the adjacent stator tooth.

18. The method according to claim 17, wherein a chamfer is formed on an end of the inner surface of the short pole shoe next to the notch.

19. The method according to claim 18, wherein the notch deviates from a symmetric center of an adjacent tooth portion for 45 to 135 electric degrees.

20. The method according to claim 11, wherein the motor stator is a single phase motor stator.
